(19) United States
(12) Patent Application Publication
(10) Pub. No.: US 2007/0199028 A1
(43) Pub. Date: Aug. 23, 2007

(54) Integrated in-seat personal video display systems

(76) Inventor: Frank Yau, Redwood City, CA (US)

Correspondence Address: FRANK YAU, 258 NICE COURT, REDWOOD CITY, CA, 94065, US

(21) Appl. No.: 11/705,235

(22) Filed: Feb. 10, 2007

Related U.S. Application Data
(60) Provisional application No. 60/772,441, filed on Feb. 10, 2006.

(51) Int. Cl. H04N 7/18; H04N 3/14

(52) U.S. Cl. 725/77; 348/790; 725/75

(57) ABSTRACT

Methods of in-seat personal video display system integration for simpler and flexible installations consist of integrated personal video display hardware or interchangeable modular compartmented options with enhanced interactive features and functions to provide efficient and cost effective integrated in-seat personal video display systems.

### RELATED APPLICATIONS

This application claims the priority of U.S. provisional patent application Ser. No. 60/772,441 filed on Feb. 10, 2006.

The present application incorporates herein by reference, the following U.S. applications having the same applicant and inventor as the present application:

“WIRELESS INTERACTIVE ENTERTAINMENT AND INFORMATION DISPLAY NETWORK SYSTEMS”, filed on Aug. 29, 2005 having application Ser. No. 11/215,757 with claimed priority dated Aug. 30, 2004.

“FUEL CELL POWERED WIRELESS NETWORK DISPLAY SYSTEMS”, filed on Sep. 11, 2006 having application Ser. No. 11/519,547 with claimed priority dated Sep. 19, 2005.

### FIELD OF THE INVENTION

This invention relates to systems for Integrated In-seat Personal Video Display Systems. Moreover, it pertains specifically to such systems for providing efficient and secure installation of personal video displays in passenger or audience seats without extensive modifications.

### BACKGROUND OF THE INVENTION

Video technology has enabled portable and simplified electronic video display systems for individual access of information and entertainment in real-time or on-demand while traveling on passenger planes and trains. In the recent time, personal video players or displays have been mounted or installed at or in the seats for individual passenger viewing. The prior art is cumbersome in seat installation due to added costs from numerous separate components, fabrication, material, labor, equipment, and maintenance. Aside from the physical and financial disadvantages of a fixed mounted installation in prior art, weight and space as well as complicated safety certification requirements are less attractive especially for aircraft installations. The new Integrated In-seat Personal Video Display Systems enable simpler, secure, and cost effective installation solutions that could extend to providing efficient and cost effective in-seat video display systems in any aircraft passenger cabins, train passenger cabins, passenger coaches, passenger cars, passenger ferry cabins, concert halls, lecture halls, auditoriums, stadiums, entertainment facilities, exercise facilities, waiting-rooms, shopping facilities, restaurants, campuses, classrooms, first responder vehicles, or special purpose vehicles.

Prior art in installing personal video displays in seats are cumbersome. There is a need for Integrated In-seat Personal Video Display Systems.

### SUMMARY OF THE INVENTION

In view of the limitations now present in the prior art, the present invention provides new and useful Integrated In-seat Personal Video Display Systems that are simpler in constructions, more universally usable and more versatile in operation than known system of this kind.

The purpose of the present invention is to provide new integrated features and installation methods for In-seat Personal Video Displays that have many novel features not offered by the prior art that result in a new Integrated In-Seat Personal Video Display Systems that are not apparent, obvious, or suggested, either directly or indirectly by any of the prior art.

The aspect of the invention is new systems of integrated in-seat personal video displays that enable more functional operations and installation methods for simple, secure, cost effective, and flexible mounting to passenger or audience seats, not limited to, an aircraft passenger cabin, train passenger cabin, passenger coach, passenger auto, passenger ferry cabin, concert hall, lecture hall, auditorium, stadium, entertainment facility, exercise facility, waiting-room, shopping facility, restaurant, campus, classroom, first responder vehicle, or special purpose vehicle.

The foregoing has outlined, in general, the physical aspects of the invention and is to serve as an aid to better understanding the more complete detailed description in which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTS OF THE INVENTION

Accordingly several advantages and objects of the present invention are:

A principal object of the present invention is to provide Integrated In-seat Personal Video Display Systems that will overcome the deficiencies of the prior arts.

An object of the present invention is to provide Integrated In-seat Personal Video Display Systems that are simpler and more cost effective to install for individual user access and to operate.

Another object of the present invention is to provide integrated features in the Integrated Personal Video Display to be more functional in a simpler and modular form factor to facilitate more efficient, cost effective, and flexible installation methods.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1 is a pictorial representation of an Integrated In-seat Personal Video Display System with individual in-seat personal video display tethered to a fixture and removable for individual viewing from its storage pocket which is installed in a passenger seat, audience seat, or nearby fixture according to the present invention.

FIG. 2 is a pictorial representation of an alternate embodiment on the Integrated Personal Video Display with keyboard, game and mouse pads according to the present invention.

FIG. 3 is a pictorial representation of an alternate embodiment on the Integrated Personal Video Display with keyboard, game and mouse on a cradled handset according to the present invention.

FIG. 4 is a pictorial representation of an alternate embodiment on the Integrated Personal Video Display with interchangeable modular compartments of optional features and functions that can work with and mate with the core display panel and other interchangeable compartments as needed according to the present invention.

### DETAILED DESCRIPTION OF THE INVENTION

Referring now descriptively to the drawings, the attached figures illustrate an Integrated In-seat Personal Video Display System:

The following description of the preferred embodiment of the invention is not intended to limit the scope of the invention but rather to enable any person skilled in the art to make and use this invention.

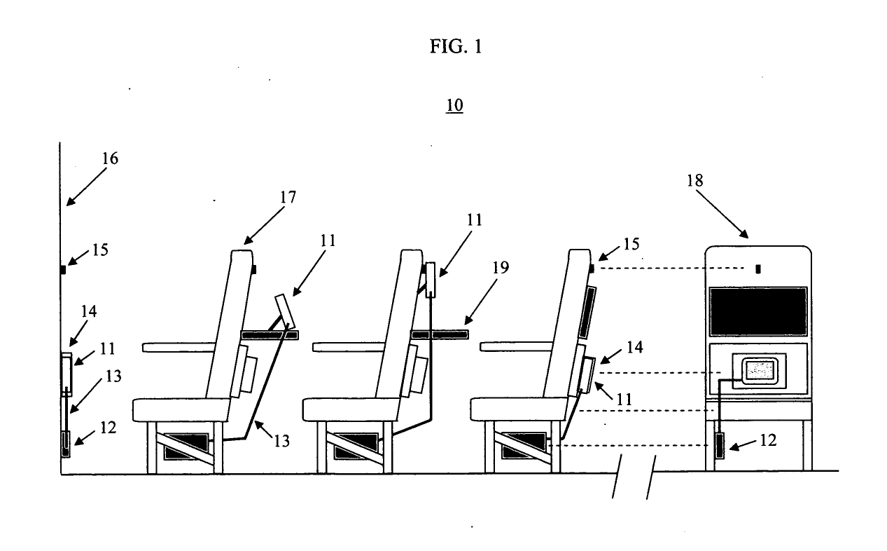

As shown in FIG. 1, the invention is an In-seat Personal Video Display System 10, which is comprised of in-seat personal video displays 11 that are normally stowed individually in storage pocket 14 which is fix mounted to a passenger or audience seat back 18 or a bulkhead 16 in front of a seat 17. The in-seat personal video display 11 is tethered for secured to the seat or fixture by a flexible cable 13 and removable from it storage pocket 14 by a user for viewing. Apparatus of the invention shall meet the related regulatory requirements for the environment which they are intended.

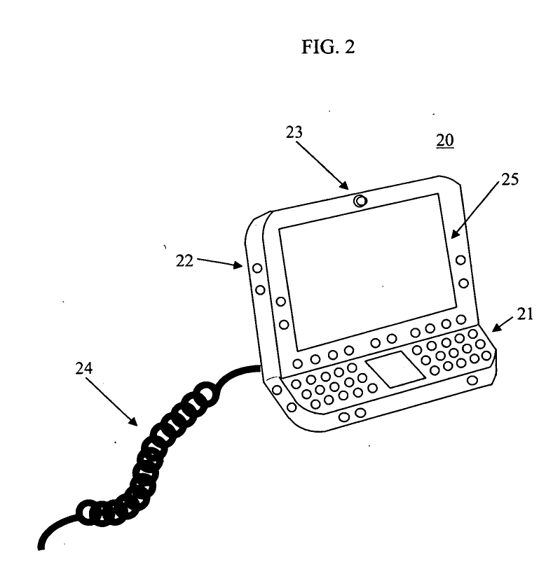

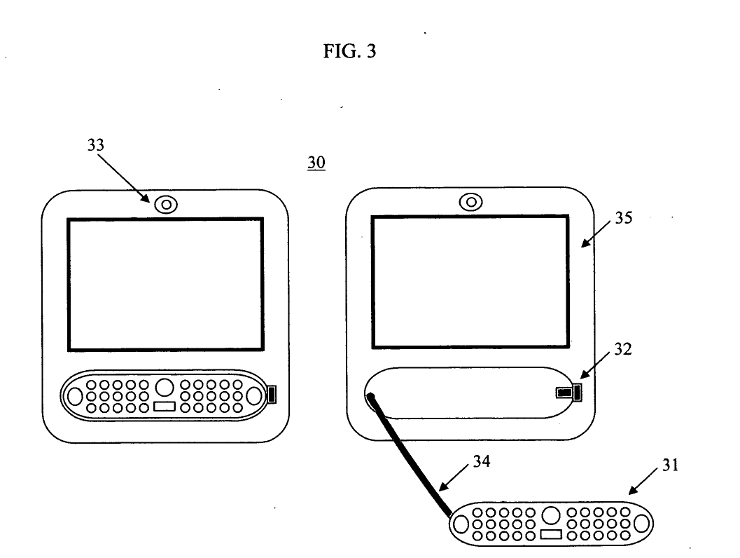

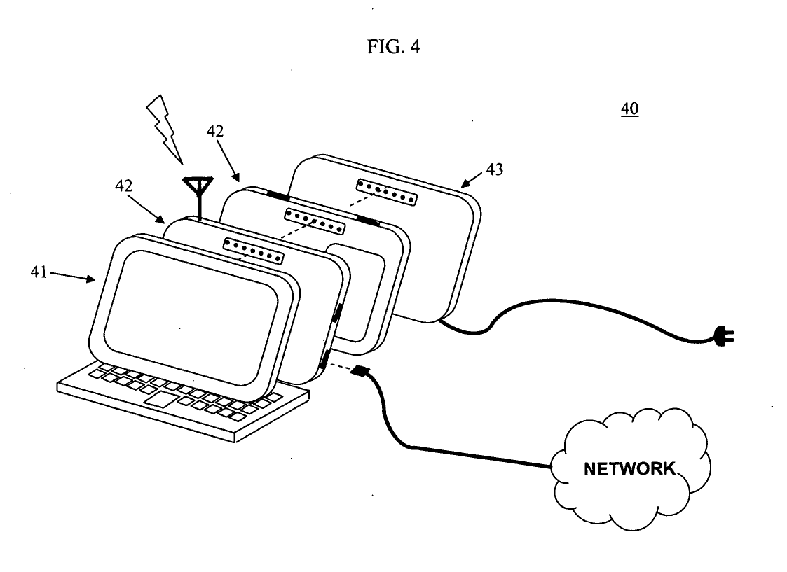

As shown in FIG. 1, the in-seat personal video display 11 (or as shown in FIG. 2, an alternate embodiment with the integrated personal video display 20 with built-in keyboard or as shown in FIG. 3, an alternate embodiment with the integrated person video display 30 with built-in keyboard on cradled handset or as shown in FIG. 4, an alternate embodiment with the integrated personal video display 40 with interchangeable modular compartments of optional functions and features) is an electronic media player with computer circuitries which includes, but not limited to, a LCD panel, optional controls by a touch-screen, built-in select key buttons and or switches. The audio is playback via a wired or wireless headset or speakers connected to the respective in-seat personal video display 11.

As shown in FIG. 1, the in-seat personal video display 11 which includes, but not limited to, onboard content storage with hard-disk drive or solid-state memory such as compact flash card and with or without wired or wireless network connectivity.

As shown in FIG. 1, the in-seat personal video display 11 would normally be stowed in storage pocket 14 which is either see-through plastic or made with netting material in the front side so the LCD screen of the in-seat personal video display 11 would be exposed to the passenger or audience at the seat 17 right behind. The storage pocket 14 would commonly be installed in the front of a seat pocket if available or similar location. The storage pocket 14 could also be installed on a bulkhead 16 in front of a passenger seat 17.

As shown in FIG. 1, the in-seat personal video display 11 which includes, but not limited to, a “kickstand” that can be pulled out from the back and rest the unit on a seat tray-table 19 or alternatively hang on the optional pivot-able bracket 15, adjustable for viewing angles, which would be installed on the back of a seat 17 or bulkhead 16 at the eye level of typical users sitting.

As shown in FIG. 1, the in-seat personal video display 11 which includes, but not limited to, powered by internal battery, micro fuel cell, or connected with flexible cable 13 to external power source 12 such as DC power converter/supply or fuel cell. Flexible cable 13 could also be coiled or retractable, with strengthened outer layer such as metal, which also provide as a security cable that attaches the in-seat personal video display 11 to the seat 17 or other fixture.

As shown in FIG. 1, the back view of a seat 18 indicates the relative positions of the components of the Integrated In-Seat Personal Video Display System 10 comparing to the side view of a seat 17.

As shown in FIG. 1, an alternate embodiment for the in-seat personal video display 11 can employ OLED or Flexible LCD technology for the display to achieve less power consumptions, lighter, more compact and thinner form factors. With the advancement of Flexible LCD without rigid material or glass, the in-seat personal video display 11 can alternatively be fixed mounted directly to the seatback 18 or tray-table 19 without significant head strike safety issues or affecting the dynamic or static loading of the seat structures.

As shown in FIG. 1, an optional membrane keyboard (not shown) and mouse pad (not shown) can be embedded on the tray-table 19 and connected to the in-seat personal video display 11 for user access to interactive functions.

As shown in FIG. 1, an optional RFID tag (not shown) or sensor (not shown) can be embedded in the in-seat personal video display 11 for disabling the functions of the device and or sound audible warning when it is out of proximity of the intended area of use.

As shown in FIG. 2, the invention is an Integrated Personal Video Display 20, with integrated built-in keyboard 21 with mouse pad or roller ball, select and game buttons 22 that are additional to features and specification for in-seat personal video display 11, which is an alternate embodiment for the in-seat personal video display 11 as shown in FIG. 1.

As shown in FIG. 2, the built-in keyboard 21 with mouse pad is tilt-able where the normal position is flat along with the display LCD panel 25, and it can be tilted at preset angles for easier handling on typing and reaching the select and game buttons 22 by user's fingers and thumbs. Alternatively, the keyboard can be stowed behind the integrated personal video display 20 and slid out in the deployed position during use.

As shown in FIG. 2, an optional built-in camera 23 is located on the integrated personal video display 20.

As shown in FIG. 2, the flexible cable 24 could also be coiled or retractable, with strengthened outer layer such as metal, which is provided as a power cable, network, and or signal wiring as well as a security cable that could attach the integrated personal video display 20 intended as illustrated in FIG. 1; additional embodiment to attach the integrated personal video display 20 to a bulkhead fixture (not shown) where a latch mount (not shown) would normally house the unit and be detachable from the latch mount housing as desired for cabin and maintenance crew functions.

As shown in FIG. 3, the invention is an Integrated Personal Video Display 30, with integrated built-in keyboard handset 31 with mouse pad or roller ball, select and game buttons that are additional to features and specification for in-seat personal video display 11, which is an alternate embodiment for the in-seat personal video display 11 as shown in FIG. 1.

As shown in FIG. 3, the built-in keyboard handset 31 is detachable from its cradle where it is stowed normally along side the LCD panel 35; it can be released from it cradle by unlocking the latch 32 for easier handling on typing and reaching the select and game buttons on the keyboard handset 31 by user's fingers and thumbs.

As shown in FIG. 3, an optional built-in camera 33 is located on the integrated personal video display 30.

As shown in FIG. 3, the keyboard handset 31 can include optional telephone functions.

As shown in FIG. 3, the flexible cable 34 could also be coiled or retractable which provides power and signal wiring to the keyboard handset 31.

As shown in FIG. 3, the integrated personal video display 30 could provide alternate embodiment for fix mounted to or near a seat (not shown) for passenger access or a bulkhead (not shown) for cabin and maintenance crew functions.

As shown in FIG. 3, the integrated personal video display 30 could provide alternate embodiment for fixed mounted or detachable on a shopping cart (not shown) for shopper access to digital media and handset voice calls and audible messages as well as RFID tag or senor for auto triggering of functions and features. Fuel cell power would be most suitable for this alternate embodiment.

As shown in FIG. 4, the invention is an Integrated Personal Video Display 40, with the following additional options to features and specification for the in-seat personal video display 11 which is an alternate embodiment for the in-seat personal video display 11 as shown in FIG. 1, with modular construction in form factor where one or plurality of interchangeable modular compartment 42 with various features and functions such as, but not limited to: keyboard and mouse pad; wireless such as WiFi, WiMax, UWB, wirless USB, satellite transceiver, or GPRS; external interface such as fast Ethernet, gigabit Ethernet, USB, Firewire, or HDMI; digital storage such as harddisk drive, compact flash memory, or secure digital memory; sensors such as RFID; Bluetooth for headsets and microphone; and handset for data, telephone, or audible messages.

As shown in FIG. 4, the interchangeable compartment modules 42 are designed to mate with the core LCD display panel 41 and other peer interchangeable compartment modules 42. The applicable interchangeable compartment modules 42 containing the desired functions or features could be added or removed depending on the required applications. The interchangeable compartment module 42 is mechanically secured and interlocked to the core LCD display panel and other mated interchangeable compartment module 42 as well as the power compartment module 43.

As shown in FIG. 4, the power compartment module 43 contains power converter, battery, and or micro fuel cell for power supply to the core LCD display panel 41 and the mated interchangeable compartment modules 42.

As shown in FIG. 4, the core LCD display panel 41 may employ TFT LCD, OLED, or Flexible LCD display technology, and it may or may not contain touch-screen, hard key buttons depending on the intended applications.

As shown in FIG. 4, an alternate embodiment of the integrated personal video display 40 can provide portability for use in or out of the seats or vehicles especially with versions of rugged mechanical designs.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art that are within the scope of the present invention. Furthermore, as any person skilled in the art will recognize from the previous detailed description and from the figures, modifications and changes can be made to the preferred embodiment of the invention without departing from the scope of this invention.

I claim:

1. An integrated in-seat personal video display system comprising: at least one in-seat personal video display with optional embedded sensor tethered for secured to a fixture or seat-back and removable from its storage pocket for individual viewing and interactive functions with optional keyboard control and respective bracket for temporary mounting.

2. The system of claim 1, wherein the in-seat personal video display is an electronic media player with computer circuitry, a LCD panel, touch-screen control or select key buttons, media storage, and with optional wired or wireless network connectivity.

3. The system of claim 1, wherein the in-seat personal video display may employ, OLED or Flexible LCD technology to achieve less power consumptions, lighter in weight, more compact and thinner in form factors.

4. The system of claim 1, wherein the in-seat personal video display using Flexible LCD without rigid material or glass on the screen can enable fix mounting directly to the seatback or its tray-table to mitigate head-strike safety issues nor affecting the dynamic or static loading of the seat structures.

5. The system of claim 1, wherein the optional keyboard can be a membrane keyboard and mouse pad embedded on the tray-table and connected to the in-seat personal display for interactive functions.

6. The system of claim 1, wherein the in-seat personal video display can be hung on optional pivot-able bracket adjustable for viewing angles on back of a seat or fixture.

7. The system of claim 1, wherein the in-seat personal video display with embedded RFID or proximity sensor for disabling the functions of the in-seat personal video display and or sound audible warning when it is out of proximity of the intended usage area.

8. An integrated personal video display enhanced with interactive features and functions comprising: electronic media player, computer circuitry, a LCD panel, select key buttons, a built-in keyboard with game and mouse pads, media storage, optional built-in camera, and optional wired or wireless network connectivity.

9. The device of claim 8, wherein built-in keyboard with game and mouse pads is tilt-able for adjustment to the preset angles for handling on typing and reaching the select keys and game buttons.

10. The device of claim 8, where in the built-in keyboard with game and mouse pads is on an integrated handset stowed in its cradle tethered to the in-seat personal video display.

11. The device of claim 8, wherein the built-in keyboard with game and mouse pads on an integrated handset with telephone functions.

12. The device of claim 8, wherein the LCD panel may employ OLED or Flexible LCD technology.

13. The device of claim 8, wherein an embedded RFID tag or sensor for disabling the functions of the device and or sound audible warning when it is out of proximity of the intended area of use.

14. An integrated personal video display constructed with interchangeable modular compartments of optional features and functions comprising: electrical power supply, electronic media player with computer circuitries, a LCD panel, optional select key buttons, optional built-in camera, and optional interchangeable modular compartments.

15. The device of claim 14, wherein one or plurality of interchangeable modular compartments with optional features and functions such as, but not limited to: keyboard, game or mouse pad; wireless functions such as WiFi, WiMax, UWB, wirless USB, satellite transceiver, or GPRS; external interfaces such as fast Ethernet, gigabit Ethernet, USB, Firewire, or HDMI; digital storages such as harddisk drive, compact flash memory, secure digital memory, or solid-state memory device; sensors such as RFID or proximity switch; Bluetooth or IR for headsets and microphone; and handset for data, telephone, or audible messages.

16. The device of claim 14, wherein the interchangeable compartment modules are designed to mate with the core LCD display panel and other peer interchangeable compartment modules where the applicable interchangeable compartment modules containing the desired functions or features could be added or removed depending on the required applications.

17. The device of claim 14, wherein the interchangeable compartment module is mechanically secured and interlocked to the core LCD display panel and other mated interchangeable compartment modules.

18. The device of claim 14, wherein the electrical power supply compartment module contains power converter, battery, and or micro fuel cell for power supply to the core LCD display panel and the mated interchangeable compartment modules.

19. The device of claim 14, wherein the LCD panel may employ OLED or Flexible LCD technology.

20. The device of claim 14, wherein can be fixed mounted or detachable on a shopping cart for shopper access to handset voice calls, digital media and audible messages with embedded with RFID tag or senor for auto triggering of functions and features also optional disabling the functions of the device and or sound audible warning when it is out of proximity of the intended area of use.
